(19) United States
(12) Patent Application Publication
(10) Pub. No.: US 2025/0217103 A1
(43) Pub. Date: Jul. 3, 2025

(54) INPUT/OUTPUT APPARATUS

(71) Applicant: Kurimoto, Ltd., Osaka (JP)

(72) Inventors: Yuya UESHIMA, Osaka (JP); Atsushi SAKAE, Osaka (JP); Hitoshi TSUJI, Osaka (JP); Shuichi AKAIWA, Osaka (JP); Keisuke KINOI, Osaka (JP)

(73) Assignee: Kurimoto, Ltd., Osaka (JP)

(21) Appl. No.: 18/851,422

(22) PCT Filed: Mar. 10, 2023
(86) PCT No.: PCT/JP2023/009256

§ 371 Date: Sep. 26, 2024

(30) Foreign Application Priority Data
Mar. 30, 2022 (JP) 2022-056937

(51) Int. Cl. G06F 3/16; G06F 3/01; G06F 3/0346

(52) U.S. Cl. CPC G06F 3/167; G06F 3/014; G06F 3/016; G06F 3/0346; G06F 2203/0331

(57) ABSTRACT

An input/output apparatus is provided that generates various kinds of sounds depending on a motion of a body of a person. An input/output apparatus includes: an auditory data storage unit storing auditory data associated with the motion of the body of the person; a motion sensor detecting the motion of the body of the person over time; and an auditory control unit reading, from the auditory data storage unit, auditory data associated with the motion of the body detected by the motion sensor and controlling a speaker based on the read auditory data.

### TECHNICAL FIELD

The present invention relates to an input/output apparatus.

### BACKGROUND ART

In recent years, services have been started that use techniques such as virtual reality (VR), augmented reality (AR) and/or mixed reality (MR) to offer a virtual space known as metaverse. A user may put on a head mount display on his/her head to enter a metaverse as an avatar. In the metaverse, the user may be able to see three-dimensional images displayed on the head mount display and/or hear sounds generated by a speaker. The user may also operate a controller worn on his/her both hands to move a virtual object displayed as a three-dimensional image. At the same time, depending on the user operation on the controller, a specific sound effect may be generated. For example, when the user depresses a button on the controller, a “beep” sound effect is generated. The user, hearing this sound, realizes that he/she has depressed the button. However, a user operation and a sound effect are associated with each other with a one-to-one correspondence regardless of the amount of depression of the button or the speed of depression, which results in a lack of reality.

While the above-discussed technique provides visual and auditory sensations to the user, techniques are also available that provide a tactile sensation in addition. For example, when the user depresses a button on the controller, a sound effect is generated and, at the same time, the controller vibrates. The user senses this vibration and thus realizes that he/she has depressed the button. However, as is the case with sound effects, a user operation and a vibration are associated with each other with a one-to-one correspondence, which results in a lack of reality.

Meanwhile, devices have been proposed that present a more real tactile sensation, rather than a simple vibration, to the user.

For example, JP 2017-138651 A (Patent Document 1) is directed to a kinesthetic presentation apparatus that presents, to an operator, a kinesthetic sensation of an object projected as an image, disclosing a kinesthetic presentation apparatus capable of linking a movement of the image with a kinesthetic sensation presented on the controller with high precision without the need for complicated control. However, this publication fails to discuss sound generation.

JP 2020-17159 A (Patent Document 2) discloses a virtual-object tactile presentation apparatus capable of giving a hand of a user a tactile sensation depending on the type of a virtual object displayed on the display. However, this publication, too, fails to discuss sound generation.

JP 2017-174381 A (Patent Document 3) discloses a method of generating a haptic effect. “Haptic” refers to a haptic and kinesthetic feedback technique that gives a user a haptic feedback effect such as a force, vibration and motion (i.e., “haptic effect”) on the user to allow the user to realize the touch. However, this publication, too, fails to discuss sound generation.

WO 2018/110003 A1 (Patent Document 4) discloses an information processing apparatus including an acquisition unit that acquires information about a motion of a user with respect to a virtual object displayed on a display unit, and an output control unit that controls display of an image including an onomatopoeia depending on the motion information and the virtual object. An onomatopoeia is thought to be an effective way of presenting a sensation on the skin as visual information, as exemplified by their use in a comic or a novel, for example. Onomatopoeias may include onomatopoeias in a narrow sense (e.g., characters representing a sound generated by an object) and mimetic words (e.g., characters representing a state of an object or a human emotion). However, this publication, too, fails to discuss sound generation.

In the field of general-purpose computers, including smartphones, techniques exist that generate a sound effect in response to a user operation on an input device such as a mouse, a keyboard or a touch screen. Further, in the field of computer games, techniques also exist that generate a sound effect in response to a depression of a button on the controller. However, again, a user operation and a sound effect are associated with each other with a one-to-one correspondence, which results in a lack of reality.

### PRIOR ART DOCUMENTS

### Patent Documents

Patent Document 1: JP 2017-138651 A
Patent Document 2: JP 2020-17159 A
Patent Document 3: JP 2017-174381 A
Patent Document 4: WO 2018/110003 A1

### SUMMARY OF THE INVENTION

### Problems to be Solved by the Invention

A problem to be solved by the present disclosure is to provide an input-output apparatus that generates various kinds of sounds depending on the motion of the body of a person.

### Means for Solving the Problems

An input/output apparatus according to the present disclosure includes: an auditory data storage unit storing auditory data associated with a motion of a body of a person; and an auditory control unit reading, from the auditory data storage unit, auditory data associated with a motion of the body of the person detected by a motion sensor detecting the motion of the body of the person over time, and controlling a speaker based on the read auditory data.

### BRIEF DESCRIPTION OF THE DRAWINGS

FIG. 1 is a functional block diagram schematically showing a configuration of an input/output system according to a first embodiment.

FIG. 2 is a functional block diagram showing in detail the configuration of the input/output system shown in FIG. 1.

FIG. 3 shows details of the database in the input/output system shown in FIGS. 1 and 2, as well as its operation.

FIG. 4 is a flow chart illustrating an operation of the input/output system shown in FIGS. 1 to 3.

FIG. 5 illustrates a screen showing images of a virtual object and a finger displayed at step S14 shown in FIG. 4.

FIG. 6 illustrates a screen showing images of the virtual object and the finger displayed at step S18 shown in FIG. 4.

FIG. 7 shows details of a database in an input/output system according to a second embodiment, as well as its operation.

FIG. 8 shows details of a database in an input/output system according to a third embodiment, as well as its operation.

### EMBODIMENTS FOR CARRYING OUT THE INVENTION

### Summary of Embodiments

An input/output apparatus according to the present disclosure includes: an auditory data storage unit storing auditory data associated with a motion of a body of a person; and an auditory control unit reading, from the auditory data storage unit, auditory data associated with the motion of the body of the person detected by a motion sensor detecting the motion of the body of the person over time, and controlling a speaker based on the read auditory data.

The input/output apparatus detects the motion of the body of the person over time, reads auditory data associated with the motion, and generates a sound based on the auditory data. As a result, the input/output apparatus is capable of generating various sounds depending on the motion of the body of the person that changes over time.

The auditory data may be associated with a position of the body of the person. The motion sensor may detect the motion of the body by measuring the position of the body over time.

A sound generated based on the auditory data may be a sound effect associated with the motion of the person. Generating a sound relating to the motion of the body achieves better coordination between the motion of the body and the sound.

The auditory data may be associated with a velocity of the motion of the body.

The motion sensor may detect the motion of the body by measuring a position of the body together with an elapsed time. The input/output apparatus may further include: a velocity calculation unit calculating the velocity of the motion of the body based on the position of the body and the elapsed time measured by the motion sensor. The auditory control unit may read, from the auditory data storage unit, auditory data associated with the velocity of the motion of the body calculated by the velocity calculation unit. In such implementations, the input/output apparatus may generate various sounds depending on the velocity of the body.

The input/output apparatus may further include: a tactile data storage unit storing tactile data associated with a motion of the body of the person; and a tactile control unit reading, from the tactile data storage unit, tactile data associated with the motion of the body detected by the motion sensor, and controlling a tactile presentation device presenting a tactile sensation based on the read tactile data. In such implementations, the input/output system is capable of presenting various tactile sensations depending on the motion of the body of the person that changes over time and, at the same time, generating a sound coordinated with the tactile sensation.

The input/output apparatus may further include: a visual data storage unit storing visual data associated with the motion of the body of the person; and a visual control unit reading, from the visual data storage unit, visual data associated with the motion of the body detected by the motion sensor, and controlling an image display device displaying an image based on the read visual data. In such implementations, the input/output apparatus is capable of displaying various images depending on the motion of the body of the person that changes over time and, at the same time, generating a sound coordinated with the image.

An input/output method according to the present disclosure includes: acquiring, over time, a motion of a body of a person detected by a motion sensor; and reading, from an auditory data storage unit storing auditory data associated with the motion of the body of the person, auditory data associated with the motion of the body detected by the motion sensor and controlling a speaker based on the read auditory data.

The input/output method involves detecting a motion of the body of the person over time, reading auditory data associated with the motion, and generating a sound based on that auditory data. As a result, the input/output method is capable of generating various sounds depending on the motion of the body of the person that changes over time.

An input/output program according to the present disclosure causes a computer to perform: acquiring, over time, a motion of a body of a person detected by a motion sensor; and reading, from an auditory data storage unit storing auditory data associated with the motion of the body of the person, auditory data associated with the motion of the body detected by the motion sensor and controlling a speaker based on the read auditory data.

The input/output program enables detecting the motion of the body of the person over time, and reading auditory data associated with the motion and generating a sound based on the auditory data. As a result, the input/output program is capable of enabling generating various sounds depending on the motion of the body of the person that changes over time.

### Details of Embodiments

Now, embodiments will be described in detail with reference to the accompanying drawings. In the drawings, the same or corresponding elements are labeled with the same reference numerals and their description will not be repeated.

### First Embodiment

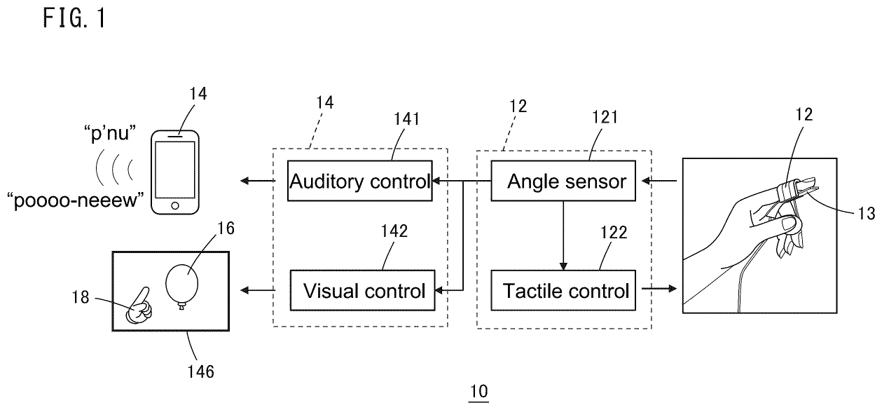

As shown in FIG. 1, an input/output system 10 according to a first embodiment includes a tap unit 12 and a smartphone (or phone) 14.

The tap unit 12 includes an angle sensor 121 that detects a motion of a finger of a person together with an elapsed time, and a tactile control unit 122 that controls the tactile sensation to be presented depending on the motion of the finger detected by the angle sensor 121. The tap unit 12 used may be a tactile presentation apparatus as discussed in JP 2020-17159 A, for example. Specifically, when a user wearing the tap unit 12 depresses a movable piece 13 with his/her index finger, the angle sensor 121 detects the angle by which the movable piece 13 has rotated from its initial position, which is to be treated as the position of the index finger. The user may move his/her finger sometimes slowly, and sometimes quickly. The angle sensor 121 may detect the angle (i.e., position) of the finger together with the associated elapsed time. In such implementations, the angle of the finger detected is a function of time.

The smartphone 14 includes an auditory control unit 141 that controls the sound to be generated depending on the motion of the finger detected by the angle sensor 121, and a visual control unit 142 that controls the image to be displayed depending on the motion of the finger detected by the angle sensor 121. The smartphone 14 used may be a portable information terminal featuring a telephone function. On the smartphone 14 are installed an operating system as well as an application program that causes a computer to function as the auditory control unit 141 and visual control unit 142.

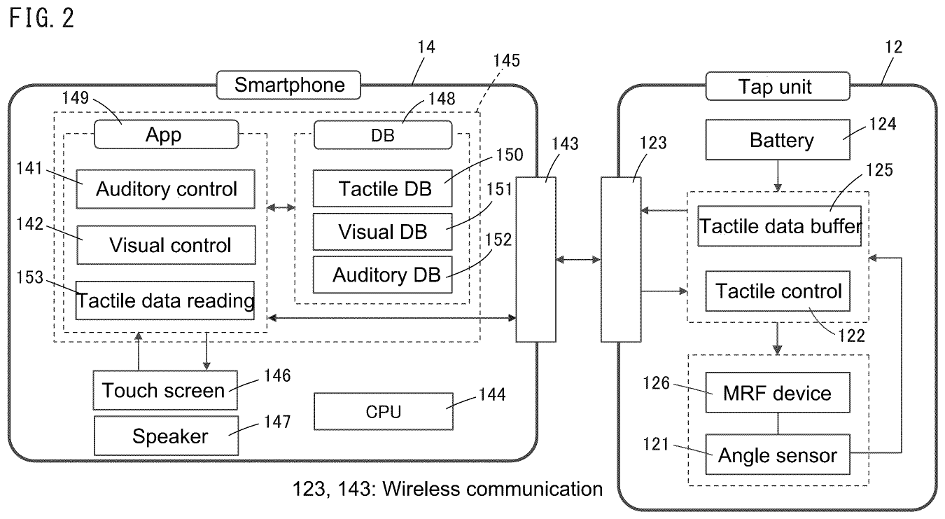

More specifically, as shown in FIG. 2, the tap unit 12 includes a wireless communication unit 123, a battery 124, a tactile data buffer 125, the tactile control unit 122, an MRF device 126, and the angle sensor 121. The smartphone 14 includes a wireless communication unit 143, a central processing unit (CPU) 144, an input/output device 145, a touch screen 146, and a speaker 147. The input/output device 145 includes a database (DB) 148 and an application program (or app) 149. The database 148 includes a tactile database (i.e., tactile data storage unit) 150, a visual database (i.e., visual data storage unit) 151, and an auditory database (i.e., auditory data storage unit) 152. The application program 149 includes a program that causes the CPU 144 to function as the auditory control unit 141, a program that causes the CPU 144 to function as the visual control unit 142, and a program that causes the CPU 144 to function as a tactile data reading unit 153. The auditory control unit 141 reads auditory data from the auditory database 152 and sends the auditory data that has been read to the speaker 147. The visual control unit 142 reads visual data from the visual database 151 and sends the visual data that has been read to the touch screen 146. The tactile data reading unit 153 reads tactile data from the tactile database 150 and sends the tactile data that has been read to the tap unit 12. The touch screen 146 includes a display function for displaying images and an input function for receiving an operation by the finger of the user. The speaker 147 generates a sound (i.e., voice, music, sound effect, etc.).

Each of the wireless communication units 123 and 143 includes a short-range wireless module, for example, such that the tap unit 12 and smartphone 14 are wirelessly connected to each other. The embodiment is not limited to wireless connection; the tap unit 12 and smartphone 14 may be connected to each other via a cable. The tactile data buffer 125 stores tactile data sent from the smartphone 14. More details will be given further below. The MRF device 126 includes a magneto-rheological fluid (not shown) and a coil (not shown) wound around the magneto-rheological fluid. The tactile control unit 122 controls the amount of current to be supplied to the coil of the MRF device 126 by the battery 124. Thus, the MRF device 126 presents an appropriate tactile sensation to the finger of the person operating the tap unit 12. In lieu of an MRF device 126, an actuator such as a motor or an oscillator element may be employed. The actuator operates depending on the amount of current to present a tactile sensation.

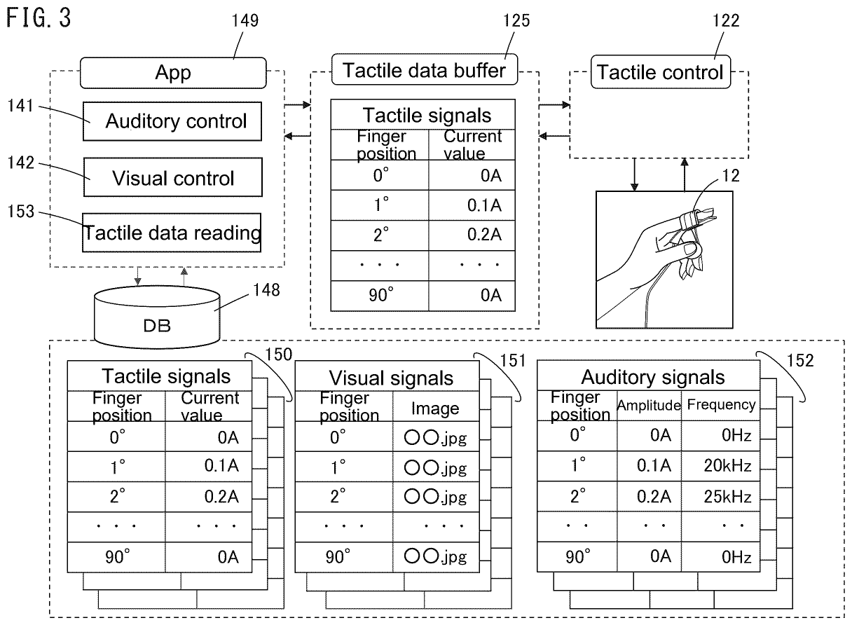

As shown in FIG. 3, the tactile database 150 stores, in advance, a plurality of tactile data corresponding to a plurality of virtual objects. Each of the tactile data includes a tactile signal representing a tactile sensation of the corresponding virtual object. Each tactile signal includes a plurality of finger positions and a plurality of corresponding current values. A finger position includes a finger angle ranging from 0 to 90 degrees in 1-degree increments. In the present exemplary implementation, a tactile signal associated with the virtual object “rubber balloon” is shown. Such a tactile signal represents a tactile sensation from a contact with the “rubber balloon”. In lieu of a tactile sensation that would be actually felt upon contact with a real object, it is possible to represent a virtual tactile sensation from a contact with a cheek, a palm or an arm, for example, of an avatar in a metaverse or a nonexistent character in an animation or a game.

The visual database 151 stores, in advance, a plurality of visual data corresponding to a plurality of virtual objects. Each of the visual data includes a visual signal (i.e., image signal) representing a visual sensation of the corresponding virtual object. Each visual signal includes a plurality of finger positions and a plurality of corresponding image files. In the present exemplary implementation, a visual signal associated with the virtual object “rubber balloon” is shown.

The auditory database 152 stores, in advance, a plurality of auditory data corresponding to a plurality of virtual objects. Each of the auditory data includes an auditory signal (i.e., audio signal) representing an auditory sensation of the corresponding virtual object. Each auditory signal includes a plurality of finger positions, a plurality of corresponding amplitudes, and corresponding frequencies. In the present exemplary implementation, an auditory signal associated with the virtual object “rubber balloon” is shown. Such an auditory signal may represent not only a sound that would be actually heard upon contact with a real object, but also a virtual sound (inclusive of a sound effect) that is assumed to occur upon contact with a nonexistent character or object.

Next, operations of the input/output system according to the first embodiment will be described.

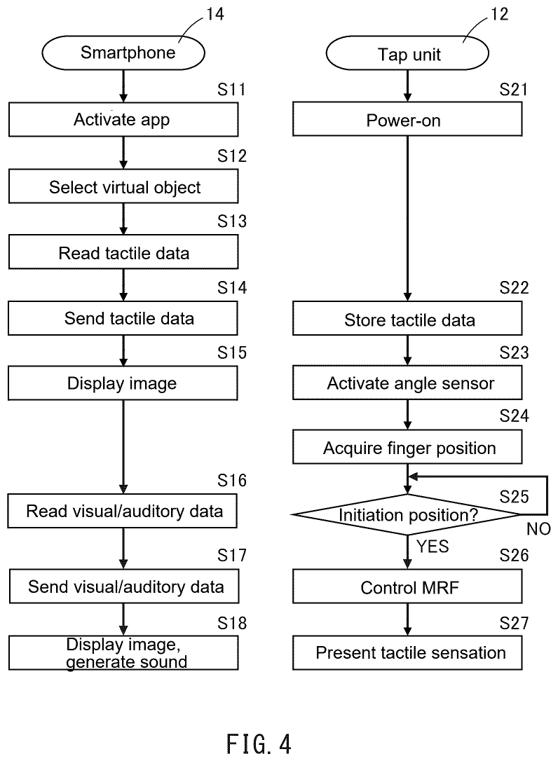

Referring to FIG. 4, at step S11, the smartphone 14, in response to a user operation, activates the application program 149. Meanwhile, at step S21, the tap unit 12, in response to a user operation, is powered on. Thus, the tap unit 12 is wirelessly connected to the smartphone 14.

At step S12, the smartphone 14, in response to a user operation, selects the desired virtual object from among a plurality of virtual objects, e.g., “rubber balloon”.

In the smartphone 14, at step S13, the tactile data reading unit 153 reads, from the tactile database 150, the tactile data (i.e., tactile signal) corresponding to the selected virtual object and, at step S14, sends the tactile data that has been read to the tap unit 12.

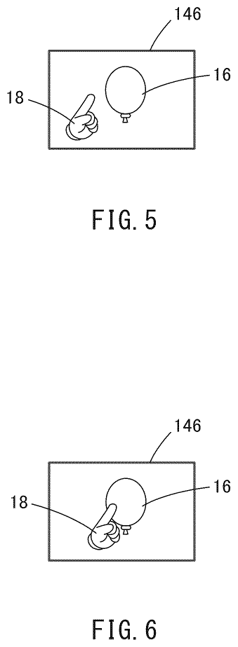

At step S15, the smartphone 14 controls the touch screen 146 to display images of the selected virtual object 16 and the finger 18, as shown in FIG. 5. Initially, the finger 18 is displayed as being spaced apart from the virtual object 16.

Meanwhile, the tap unit 12 receives the tactile data from the smartphone 14 and, at step S22, stores it in the tactile data buffer 125.

At step S23, the tap unit 12 activates the angle sensor 121.

At step S24, the tactile control unit 122 acquires the position of the finger detected by the angle sensor 121 and sends the acquired finger position to the smartphone 14. From this onward, the tactile control unit 122 continues to repeat this operation. Thus, the tactile control unit 122 continues to sends, to the smartphone 14, a finger position detected by the angle sensor 121 together with the associated elapsed time.

Meanwhile, at step S16, the visual control unit 142 reads, from the visual database 151, a visual data (i.e., the image file of a visual signal) corresponding to the finger position sent by the tap unit 12. The auditory control unit 141 reads, from the auditory database 152, an auditory data (i.e., the amplitude and frequency of an auditory signal) corresponding to the finger position sent by the tap unit 12.

At step S17, the visual control unit 142 sends the visual data that has been read to the touch screen 146. The auditory control unit 14 sends the auditory data that has been read to the speaker 147.

At step S18, the touch screen 146 displays an image based on the visual data sent by the visual control unit 142. The speaker generates a sound based on the auditory data sent by the auditory control unit 141.

Meanwhile, at step S27, the tactile control unit 122 determines whether the finger position acquired has reached a specified position, or more specifically, whether the displayed finger 18 has contacted the virtual object 16, as shown in FIG. 6. If the finger position has reached the specified position, at step S26, the tactile control unit 122 initiates control of the MRF device 126. The tactile control unit 122 reads, from the tactile data buffer 125, a tactile data (i.e., the current value of a tactile signal) corresponding to the finger position acquired.

At step S27, the tactile control unit 122, based on the tactile data (i.e., the current value of the tactile signal) that has been read, supplies a specified amount of current to the coil of the MRF device 126 (i.e., applies a voltage to the coil that is required to cause a specified amount of current to flow therethrough). Thus, the MRF device 126 presents a tactile sensation depending on the finger position.

Thus, the input/output system according to the first embodiment, in response to a motion of the body of the person that changes over time, is capable of outputting coordinated images, sounds and tactile sensations. For example, when the user deforms the virtual object “rubber balloon” with his/her finger, a quick deformation causes generation of the sound effect “p'nu”, whereas a slow deformation causes generation of the sound effect “poooo-neeew”. In addition, images and tactile sensations coordinated with these sound effects are output. As a result, the auditory, visual and tactile sensations are coordinated with one another, which enhances reality.

### Second Embodiment

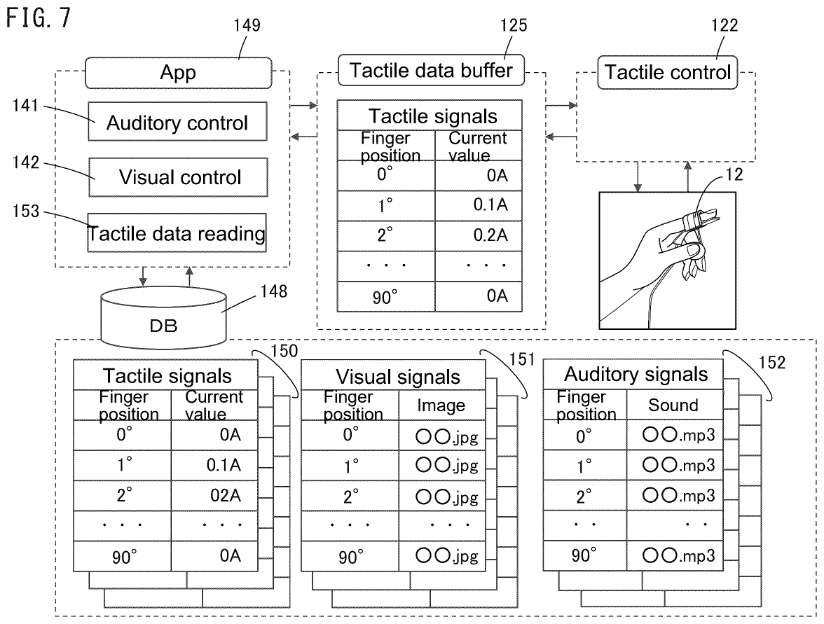

According to the first embodiment, an auditory signal includes an amplitude and a frequency; alternatively, as shown in FIG. 7, an auditory signal may include an audio file.

### Third Embodiment

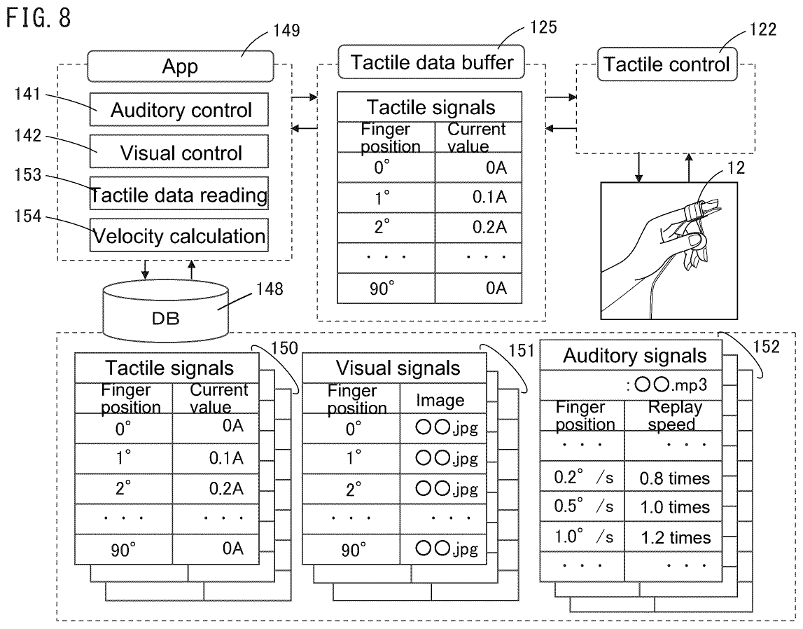

According to the first embodiment, an auditory signal includes a finger position, an amplitude and a frequency, and, according to the second embodiment, includes a finger position and an audio file; alternatively, as shown in FIG. 8, an auditory signal may include an audio file that provides a base, and finger velocities and replay speeds. In such implementations, the application program 149 further includes a program that causes the CPU 144 to function as a velocity calculation unit 154. The velocity calculation unit 154 calculates the velocity of the finger (i.e., finger velocity) based on the finger position (i.e., angle) measured by the angle sensor 121 and the elapsed time. For example, the velocity calculation unit 154 may calculate the moving distance of the finger per unit time, or may differentiate the finger position with respect to time. The auditory control unit 141 reads, from the auditory database 152, an auditory data corresponding to the finger velocity calculated by the speed calculation unit 154, which is to be treated as a replay speed. In such implementations, when an initiation position is reached, this input/output system initiates playing the base audio file and subsequently generates various sounds depending on the velocity of the finger.

### Other Embodiments

In lieu of the finger, the motion sensor may detect a motion of the head, a shoulder, an arm, the trunk, the hip, a leg, or a combination thereof. Further, in lieu of the angle of the body, the motion sensor may detect one-dimensional, two-dimensional, or three-dimensional coordinates of the body. Furthermore, the motion sensor may be replaced by a camera. In such implementations, an image of the body captured by the camera may be analyzed and the resulting coordinates may be used as detection results. Moreover, there may be not only one motion sensor, but two or more motion sensors. Furthermore, embodiments of the present invention encompass a non-transitory storage medium storing a program that causes a computer to function as an input/output device or an input/output system.

Although embodiments of the present invention have been described, the present invention is not limited to the above-described embodiments, and various improvements and modifications are possible without departing from the spirit of the invention.

### REFERENCE SIGNS LIST

10: input/output system
121: angle sensor
122: tactile control unit
126: MRF device
141: auditory control unit
142: visual control unit
145: input/output device
146: touch screen
147: speaker
148: database
149: application program
150: tactile database
151: visual database
152: auditory database
153: tactile data reading unit
154: velocity calculation unit

1. An input/output apparatus comprising:
an auditory data storage unit storing auditory data associated with a motion of a body of a person; and
an auditory control unit reading, from the auditory data storage unit, auditory data associated with a motion of a body of a person detected by a motion sensor detecting the motion of the body of the person over time, and controlling a speaker based on the read auditory data.

2. The input/output apparatus according to claim 1, wherein:
the auditory data is associated with a position of the body of the person; and
the motion sensor detects the motion of the body by measuring the position of the body over time.

3. The input/output apparatus according to claim 1, wherein a sound generated based on the auditory data is a sound effect associated with the motion of the body.

4. The input/output apparatus according to claim 1, wherein:
the auditory data is associated with a velocity of the motion of the body; and
the motion sensor detects the motion of the body by measuring a position of the body together with an elapsed time,
the input/output apparatus further comprising:
a velocity calculation unit calculating the velocity of the motion of the body based on the position of the body and the elapsed time measured by the motion sensor,
wherein the auditory control unit reads, from the auditory data storage unit, auditory data associated with the velocity of the motion of the body calculated by the velocity calculation unit.

5. The input/output apparatus according to claim 1, further comprising:
a tactile data storage unit storing tactile data associated with the motion of the body of the person; and
a tactile control unit reading, from the tactile data storage unit, tactile data associated with the motion of the body detected by the motion sensor, and controlling a tactile presentation device presenting a tactile sensation based on the read tactile data.

6. The input/output apparatus according to claim 1, further comprising:
a visual data storage unit storing visual data associated with the motion of the body of the person; and
a visual control unit reading, from the visual data storage unit, visual data associated with the motion of the body detected by the motion sensor, and controlling an image display device displaying an image based on the read visual data.

7. An input/output method comprising:
acquiring, over time, a motion of a body of a person detected by a motion sensor; and
reading, from an auditory data storage unit storing auditory data associated with the motion of the body of the person, auditory data associated with the motion of the body detected by the motion sensor and controlling a speaker based on the read auditory data.

8. An input/output program for causing a computer to perform:
acquiring, over time, a motion of a body of a person detected by a motion sensor; and
reading, from an auditory data storage unit storing auditory data associated with the motion of the body of the person, auditory data associated with the motion of the body detected by the motion sensor and controlling a speaker based on the read auditory data.
